(19) United States
(12) Patent Application Publication
(10) Pub. No.: US 2025/0285156 A1
(43) Pub. Date: Sep. 11, 2025

(54) Electric Car App

(71) Applicant: Ian Guyton, Lancaster, CA (US)

(72) Inventor: Ian Guyton, Lancaster, CA (US)

(21) Appl. No.: 18/597,705

(22) Filed: Mar. 6, 2024

(51) Int. Cl. G06Q 30/0601

(52) U.S. Cl. CPC G06Q 30/0621

(57) ABSTRACT

I went to the local Cinemark 22 and IMAX movie theater Saturday afternoon on Oct. 23, 2021 to watch Dune, and in the movie theater parking lot, I saw 2 Volta Electric Car charging stations that allows a person to simultaneously watch a movie and charge their electric cars. That day, I began to think about how the person getting their electric car charged while watching a movie could tell their family members, friends, and colleagues about this experience, which would spread the progressively growing incentive to make their next car purchase, if they haven't already, be an electric car.

### CROSS-REFERENCE TO RELATED APPLICATIONS

N/A.

### STATEMENT REGARDING FEDERALLY SPONSORED RESEARCH OR DEVELOPMENT

N/A yet.

### THE NAMES OF THE PARTIES TO A JOINT RESEARCH AGREEMENT

N/A yet.

### INCORPORATION-BY-REFERENCE OF MATERIAL SUBMITTED ON A COMPACT DISC OR AS A TEXT FILE VIA THE OFFICE ELECTRONIC FILING SYSTEM (EFS-WEB)

N/A yet.

### STATEMENT REGARDING PRIOR DISCLOSURES BY THE INVENTOR OR A JOINT INVENTOR

Disclosed idea to thoughtstopaper.com on around Feb. 15, 2021, patent pending expired on Sep. 20, 2022.

### BACKGROUND OF THE INVENTION

Since the introduction of the automobile in the late 19th century, car sale method have largely remained unchanged up to present day since their initial conception. Car sales over this period typically go through a car dealership, in which dealerships buy or hold inventory, and rely on car salespeople to sell these cars to willing patrons. A big issue here is that the options for the end user are naturally limited to the dealership's lot, i.e., what they see is what they get.

The present invention revolutionizes the automobile sales industry by way of introducing a network to connect users to freelance designers, who serve to assist with designing a custom electric car to the user's liking, to which the user can then go on to have manufactured.

### (1) FIELD OF THE INVENTION

The present invention relates generally to automobile customization and entertainment platform. More specifically, a method for a software application comprising a network that connects users to freelance workers for assistance and service offerings for designing and building electric cars.

### (2) DESCRIPTION OF RELATED ART INCLUDING INFORMATION DISCLOSED UNDER 37 CFR 1.97 AND 1.98

N/A.

### BRIEF SUMMARY OF THE INVENTION

Simply said, I want the user to buy an electric car that was built just for that person by their typed input on the app. Instead of getting some features that they wish for, and settling for the rest when purchasing a car, the user, working with a freelancer who has a list of prepared questions for the car to built, can create a car to be built that is at least 90% of what the user wanted.

### DETAILED DESCRIPTION OF THE INVENTION

The present invention, herein referred to as “Electric Car App”, is a method for a software application which connects users to a database of freelance workers who will assist the user to design customized electric cars based on answers from questions provided, in exchange for a service fee. The online freelancers then create an illustration of how the user's car would look, and function based on the answers to questions such as, “what does the user want to express with this electric car?”, or “How does the user want to feel when they drive this electric car?”. To this extent, the app can serve as an entertainment platform for artistic expression, but the scope of function the present invention is capable of achieving extends well beyond this, in that the customized car can actually be manufactured for users who so desire.

Present methods for car sales typically require and involve a car salesperson telling a potential client what car(s) they have for sale. Electric Car App revolutionizes the present model and provides a much more personalized and customizable option, by way of the customer answering a series of questions and then obtaining a picture of nearly identical proportions to exactly as described. Although the invention has been explained in relation to its preferred embodiment, it is to be understood that many other possible modifications and variations can be made without departing from the spirit and scope of the invention.

### BRIEF DESCRIPTION OF THE SEVERAL VIEWS OF THE DRAWING(S)

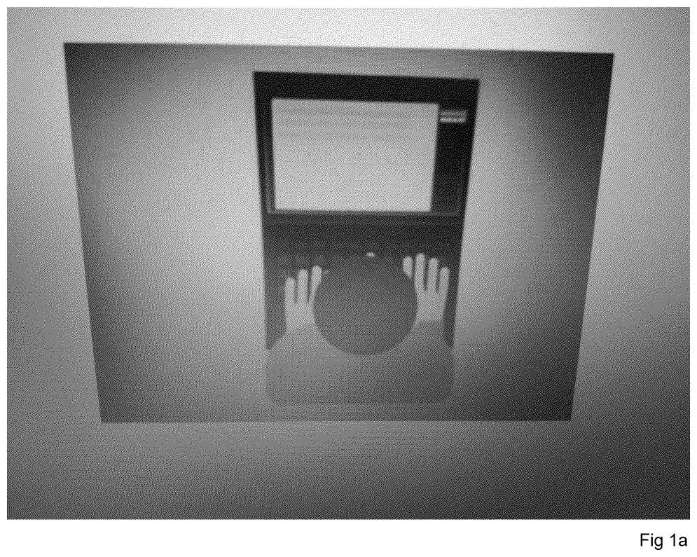

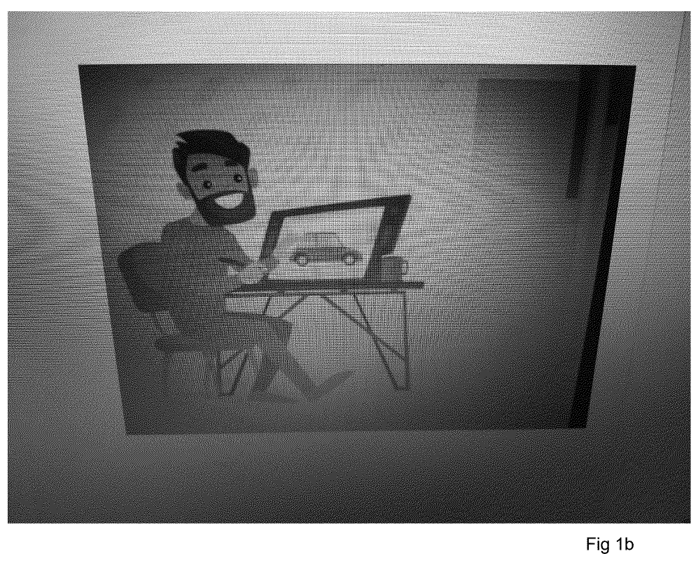

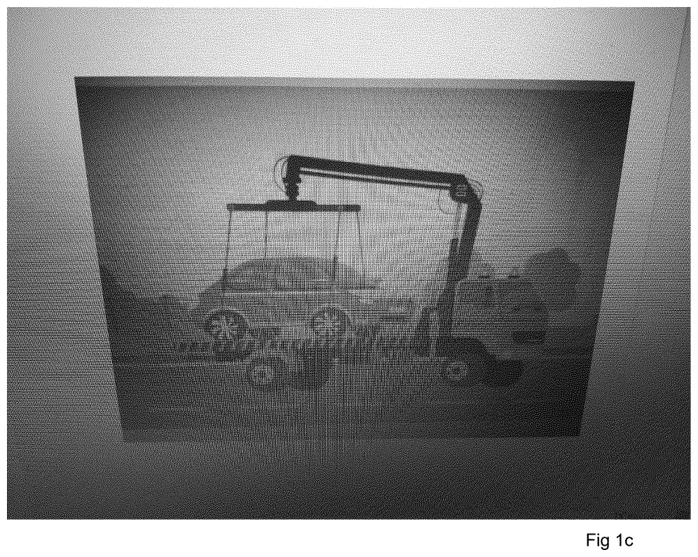

FIG. 1a shows Electric Car App user filling out a questionnaire from a freelancer describing the car to be built.
Image designed by Pinterest.com.

FIG. 1b shows the freelancer's design for the car to be built from Electric Car App user's input on questionnaire.
Image designed by Adobe.com.

FIG. 1c shows the car is built for Electric Car App user, then towed to client's home.
Image designed by freepik.com.

For this “Electric Car App” innovation the financial profiteers could be:
Freelancers from the app.
EV manufacturers.
Secondary market, car dealerships could sell used customized ev cars from previous owners to new clients.
Car insurance companies for ev driver clients.
Car repair shops that service ev cars.
Total profit from end to end of client using the Electric Car App, to customized by freelancer, to sold and delivered ev to purchaser's home can be split 60/40 with the inventor getting 40 percent but hope to move to 50/50.

1) Clients get electric vehicle built to their liking through fillable questionnaire provided by a freelancer.

2) Databank with wide selection of ev parts graphics.

3) Clients can be guided by freelancer for approval through the various stages of the ev being built.
